(19) United States
(12) Patent Application Publication
(10) Pub. No.: US 2025/0036940 A1
(43) Pub. Date: Jan. 30, 2025

(54) FREQUENCY-AWARE MASKED AUTOENCODERS FOR MULTIMODAL PRETRAINING ON FREQUENCY-BASED SIGNALS

(71) Applicant: Apple Inc., Cupertino, CA (US)

(72) Inventors: Ali MOIN, San Mateo, CA (US); Ran LIU, Atlanta, GA (US); Ellen L. ZIPPI, Daly City, CA (US); Mohammad Hadi POUR ANSARI, Sunnyvale, CA (US); Christopher M. SANDINO, Belmont, CA (US); Erdrin AZEMI, San Mateo, CA (US)

(21) Appl. No.: 18/637,161

(22) Filed: Apr. 16, 2024

Related U.S. Application Data
(60) Provisional application No. 63/529,666, filed on Jul. 28, 2023.

(51) Int. Cl. G06N 3/08

(52) U.S. Cl. CPC G06N 3/08

(57) ABSTRACT

The subject technology provides frequency-aware masked autoencoders for multimodal pretraining on frequency-based signals. An apparatus receives input data comprising frequency-based signal information associated with one or more modalities. The apparatus transforms the input data from a time domain to a frequency domain. The apparatus generates a frequency-embedded latent representation of the input data comprising time-domain and frequency-domain information. The apparatus also generates a masked frequency-embedded latent representation by masking one or more frequency components in the frequency-embedded latent representation. The apparatus produces a trained machine learning model by training a neural network to predict one or more masked frequency components of the frequency-embedded latent representation.

### CROSS-REFERENCE TO RELATED APPLICATION(S)

This application claims the benefit of U.S. Provisional Application Ser. No. 63/529,666, entitled “FREQUENCY-AWARE MASKED AUTOENCODERS FOR MULTIMODAL PRETRAINING ON FREQUENCY-BASED SIGNALS,” and filed on Jul. 28, 2023, the disclosure of which is expressly incorporated by reference herein in its entirety.

### TECHNICAL FIELD

The present description generally relates to frequency-aware masked autoencoders for multimodal pretraining on frequency-based signals.

### BACKGROUND

Various physiological parameters of a user can be measured and analyzed to estimate other physiological measures indicative of the user's physiological state. Computer hardware has been utilized to make improvements across different industry applications including applications used to assess and monitor physiological activities.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment in accordance with one or more implementations.

FIG. 2 illustrates an example computing architecture for a system providing for multimodal pretraining on frequency-based signals using machine learning in accordance with one or more implementations.

FIG. 3 conceptually illustrates an example overview of frequency-aware encoding and frequency-preserving pretraining in accordance with one or more implementations.

FIGS. 4A-4B are schematic diagrams illustrating an example architecture for performing frequency-aware encoding and frequency-preserving pretraining in accordance with one or more implementations.

FIG. 5 is a flow chart of an example process that may be performed for frequency-aware encoding and frequency-preserving pretraining in accordance with one or more implementations.

FIG. 6 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Machine learning has seen a significant rise in popularity in recent years due to the availability of training data, and advances in more powerful and efficient computing hardware. Machine learning may utilize models that are executed to provide predictions in particular applications.

Recent advancements in wearable device technology have led to the capability to record various physiological signals, which can be utilized for monitoring the overall wellness of users including mental and/or emotional states. Two of the most commonly collected physiological signals from wearable devices are photoplethysmography (PPG) and electrocardiogram (ECG). Cardiac electrical activity is measured by ECG, containing information about cardiovascular health, while volumetric changes in arterial blood flow are measured by PPG, encompassing a wide range of biological information. These physiological signals are employed on a wearable electronic device for the detection of certain health conditions, such as atrial fibrillation, and the monitoring of specific health metrics, such as blood oxygen. The manifestation of physical and mental states in a user can be achieved through a variety of complementary physiological responses or frequency-based signals. For instance, brain activities indicative of human emotions can be detected through electroencephalography (EEG), while facial expressions like smiling can be decoded by recording muscle contractions using electromyography (EMG). Moreover, a combination of these modalities enables the decoding of emotions, such as happiness.

Inspired by advancements in foundation models for language and vision, the use of transformers and large-scale pretraining for frequency-based signals is explored in the present disclosure. An architecture for frequency-based signals is introduced, which can be trained on multiple modalities and easily adapted to new modalities or tasks. The proposed model incorporates three key features: (i) an efficient identification of local and global information from frequency-based signals by leveraging global filters in the frequency space through a frequency-aware architecture; (ii) the sharing of encoder weights across different channels using either general-purpose or modality-specific filters, achieved by a channel-independent design; and (iii) the effective combination of an arbitrary number of modalities through a modality-fusion transformer. The robustness of the proposed architecture is demonstrated on multiple frequency-based signal datasets, exhibiting superior performance compared to single-modality models and outperforming in transfer learning tasks. In the present disclosure, the utilization of the multi-modal information not only facilitates the construction of enhanced and resilient representations of the human body and mental states but also provides valuable insights to researchers about the contributions of each frequency-based signal to specific predictions and the extent of their informational overlap.

In the domain of multi-modal learning, challenges in data acquisition often confront task-specific datasets. As a result, models trained on such datasets tend to exhibit fragility and sensitivity to data distribution and task specification. Recently, remarkable generalization and zero-shot capabilities have been demonstrated in the language-vision domains through large-scale multimodal pre-training. Considering these advancements, an investigation is undertaken to explore the application of similar pre-training in the frequency-based signal domain. However, performing multimodal pre-training on frequency-based signals proves to be particularly challenging due to significant distributional shifts between the pre-training and downstream datasets. These challenges may fall into two categories: (i) substantial distributional shifts within each modality for frequency-based signals, where data variations occur across tasks, subjects, and even recording sessions within subjects, attributed to slight changes in sensor placement and recording conditions, or, (ii) multimodal frequency-based signals may encounter strong domain shifts across modalities, leading to alterations in the connections between different modalities. These cross-modal domain shifts may arise from unimodal shifts, where changes in inputs within a single modality can affect the connections across different modalities. Moreover, multi-modal frequency-based signals often face scenarios of modality mismatch, wherein modalities may be dropped or replaced with new modalities providing consistent bio-information. Effectively addressing these issues is crucial to harness the potential of multi-modal pre-training in frequency-based signals.

The subject technology provides techniques for an architecture that incorporates frequency information in time series to mitigate distributional shifts and enable multimodal pre-training on frequency-based signals. The model includes two key components: (i) a frequency-aware learning module and (ii) a frequency-preserving pre-training module. The effectiveness of using frequency domain information to address generalization issues has been shown in previous works, either relying on encoders from both the time and frequency domains, or utilizing complicated sampling and combining modules to incorporate frequency information. A multi-head frequency filter layer is provided and coupled inside a transformer architecture to build a frequency-aware learning module. Furthermore, to extend this frequency awareness into a multimodal pre-training setting, it is coupled with a frequency-preserving pre-training design. The method can modify legacy masked autoencoding strategies to preserve frequency awareness during reconstruction, and the corresponding channel independence design ensures robustness to domain shifts in multimodal connections. The model presents a pure reconstruction-based multimodal pre-training architecture. Coupled with the channel-independence design, the model demonstrates robustness for domain shifts across modalities. The subject technology is systematically evaluated over several datasets and benchmarks. It facilitates transfer learning on frequency-based signals. The architecture can integrate and leverage information across different modalities, demonstrating robustness to modality mismatch scenarios commonly encountered in real-world cases.

A robust and computationally efficient frequency-aware transformer encoder with a multi-head frequency filter operation is proposed for performing frequency-aware learning of frequency-based signals. A frequency-preserving pre-training module is introduced to effectively integrate and utilize information across different modalities, creating a representation that is resilient to domain shifts. The method under systematic evaluation can demonstrate its robustness for two types of domain shifts: shifts within each modality and across modalities. Additionally, pre-training on multiple modalities can enhance transfer/generalization ability, making it practical for various real-world scenarios.

Implementations of the subject technology improve the ability of a given electronic device to provide sensor-based, machine-learning generated feedback to a user (e.g., a user of the given electronic device). These benefits therefore are understood as improving the computing functionality of a given electronic device, such as an end user device which may generally have less computational and/or power resources available than, e.g., one or more cloud-based servers.

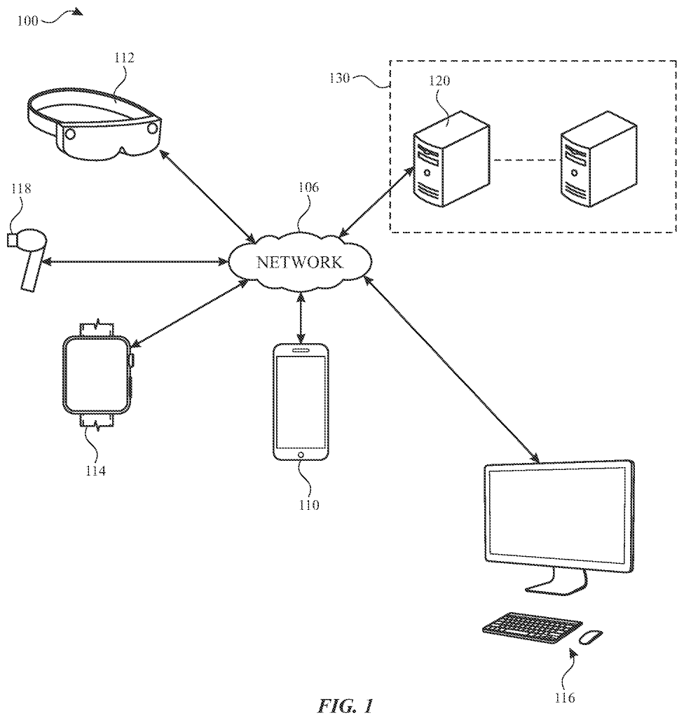

FIG. 1 illustrates an example network environment 100 in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 includes an electronic device 110, an electronic device 112, an electronic device 114, an electronic device 116, an electronic device 118, and a server 120. The network 106 may communicatively (directly or indirectly) couple the electronic device 110 and/or the server 120. In one or more implementations, the network 106 may be an interconnected network of devices that may include, or may be communicatively coupled to, the Internet. For explanatory purposes, the network environment 100 is illustrated in FIG. 1 as including the electronic device 110, the electronic device 112, the electronic device 114, the electronic device 116, the electronic device 118, and the server 120; however, the network environment 100 may include any number of electronic devices and any number of servers or a data center including multiple servers.

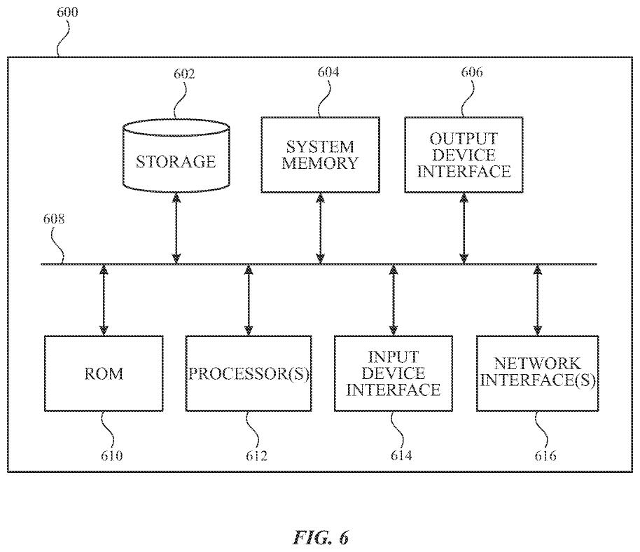

The electronic device 110 may be, for example, a desktop computer, a portable computing device such as a laptop computer, a smartphone, a peripheral device (e.g., a digital camera, headphones), a tablet device, a wearable device such as a watch, a band, and the like. In FIG. 1, by way of example, the electronic device 110 is depicted as a mobile electronic device (e.g., smartphone). The electronic device 110 may be, and/or may include all or part of, the electronic system discussed below with respect to FIG. 6.

The electronic device 112 may be, for example, desktop computer, a portable computing device such as a laptop computer, a smartphone, a peripheral device (e.g., a digital camera, headphones), a tablet device, or a wearable device such as a head mountable portable system, that includes a display system capable of presenting a visualization of an extended reality environment to a user. In FIG. 1, by way of example, the electronic device 112 is depicted as a head mountable portable system. The electronic device 112 may be, and/or may include all or part of, the electronic system discussed below with respect to FIG. 6.

The electronic device 114 may be, for example, desktop computer, a portable computing device such as a laptop computer, a smartphone, a peripheral device (e.g., a digital camera, headphones), a tablet device, a wearable device such as a watch, a band, and the like. In FIG. 1, by way of example, the electronic device 114 is depicted as a watch. The electronic device 114 may be, and/or may include all or part of, the electronic system discussed below with respect to FIG. 6.

The electronic device 116 may be, for example, desktop computer, a portable computing device such as a laptop computer, a smartphone, a peripheral device (e.g., a digital camera, headphones), a tablet device, a wearable device such as a watch, a band, and the like. In FIG. 1, by way of example, the electronic device 116 is depicted as a desktop computer. The electronic device 116 may be, and/or may include all or part of, the electronic system discussed below with respect to FIG. 6.

The electronic device 118 may be, for example, desktop computer, a portable computing device such as a laptop computer, a smartphone, a peripheral device (e.g., a digital camera, headphones), a tablet device, a wearable device such as a watch, a band, and the like. In FIG. 1, by way of example, the electronic device 118 is depicted as a earbud. The electronic device 118 may be, and/or may include all or part of, the electronic system discussed below with respect to FIG. 6.

In one or more implementations, one or more of the electronic devices 110-118 may provide a system for training a machine learning model using training data, where the trained machine learning model is subsequently deployed to one or more of the electronic devices 110-118. Further, one or more of the electronic devices 110-118 may provide one or more machine learning frameworks for training machine learning models and/or developing applications using such machine learning models. In an example, such machine learning frameworks can provide various machine learning algorithms and models for different problem domains in machine learning. In an example, the electronic device 110 may include a deployed machine learning model that provides an output of data corresponding to a prediction or some other type of machine learning output. In one or more implementations, training and inference operations that involve individually identifiable information of a user of one or more of the electronic devices 110-118 may be performed entirely on the electronic devices 110-118, to prevent exposure of individually identifiable data to devices and/or systems that are not authorized by the user.

The server 120 may form all or part of a network of computers or a group of servers 130, such as in a cloud computing or data center implementation. For example, the server 120 stores data and software, and includes specific hardware (e.g., processors, graphics processors and other specialized or custom processors) for rendering and generating content such as graphics, images, video, audio and multi-media files. In an implementation, the server 120 may function as a cloud storage server that stores any of the aforementioned content generated by the above-discussed devices and/or the server 120.

The server 120 may provide a system for training a machine learning model using training data, where the trained machine learning model is subsequently deployed to the server 120 and/or to one or more of the electronic devices 110-118. In an implementation, the server 120 may train a given machine learning model for deployment to a client electronic device (e.g., the electronic device 110, the electronic device 112, the electronic device 114, the electronic device 118). In one or more implementations, the server 120 may train portions of the machine learning model that are trained using (e.g., anonymized) training data from a population of users, and one or more of the electronic devices 110-118 may train portions of the machine learning model that are trained using individual training data from the user of the electronic devices 110-118. The machine learning model deployed on the server 120 and/or one or more of the electronic devices 110-118 can then perform one or more machine learning algorithms. In an implementation, the server 120 provides a cloud service that utilizes the trained machine learning model and/or continually learns over time.

In the example of FIG. 1, the electronic device 110 is depicted as a smartphone. However, it is appreciated that the electronic device 110 may be implemented as another type of device, such as a wearable device (e.g., a smart watch or other wearable device). The electronic device 110 may be a device of a user (e.g., the electronic device 110 may be associated with and/or logged into a user account for the user at a server). Although a single electronic device 110 is shown in FIG. 1, it is appreciated that the network environment 100 may include more than one electronic device, including more than one electronic device of a user and/or one or more other electronic devices of one or more other users.

Electronic devices (e.g., 110-118) including wearable devices (e.g., 112, 114, 118) can facilitate the provision of improved and objective data concerning the timing and frequency of seizures. It has been observed that patient-reported seizure counts do not consistently offer precise information, with a notable number of all seizures remaining undocumented. This underreporting stems from factors beyond the patient's control, such as postictal seizure unawareness or amnesia. For instance, seizures occurring during sleep and focal impaired awareness seizures pose the highest risk of going unrecorded. Accurate seizure counts play a crucial role in medication adjustments, monitoring changes, and other relevant aspects. Notably, status epilepticus, defined as seizure activity lasting longer than 5 minutes, can lead to permanent brain damage. Timely notification of caregivers regarding seizure activity holds the potential to prevent permanent brain damage caused by status epilepticus.

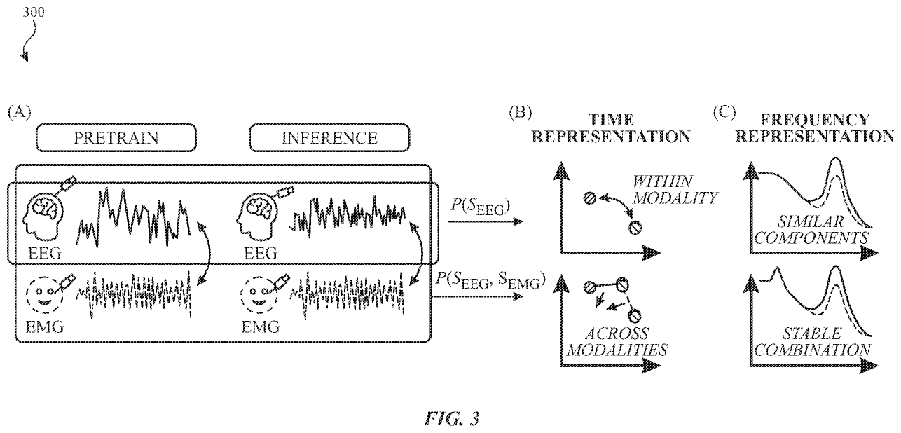

In one or more implementations, any one of the electronic devices 110-118 may include a seizure detection system that incorporates (1) multimodal frequency-based signal data acquired from any one of the electronic devices 110-118 and (2) a detection algorithm as will be described in more detail in FIGS. 3-5 to provide (3) real-time monitoring and alert notifications. For example, when a seizure is detected by at least one of the electronic devices 110-118, the system generates alert notifications to user and/or emergency contacts depending on user preferences. In one or more other implementations, a seizure occurrence (or seizure event) can be logged in memory in a privacy-sensitive manner and trackable via an on-device application of the electronic devices 110-118.

In one or more implementations, the frequency-based signals may include electromyography data recorded by at least one of the electronic devices 110-118, such as the electronic device 114, electroencephalography data recorded by at least one of the electronic devices 110-118, such as the electronic device 118, electrocardiography data recorded by at least one of the electronic devices 110-118, such as the electronic device 114, electrooculography data recorded by at least one of the electronic devices 110-118, such as the electronic device 118, and respiration data recorded by at least one of the electronic devices 110-118, such as the electronic device 118, among others.

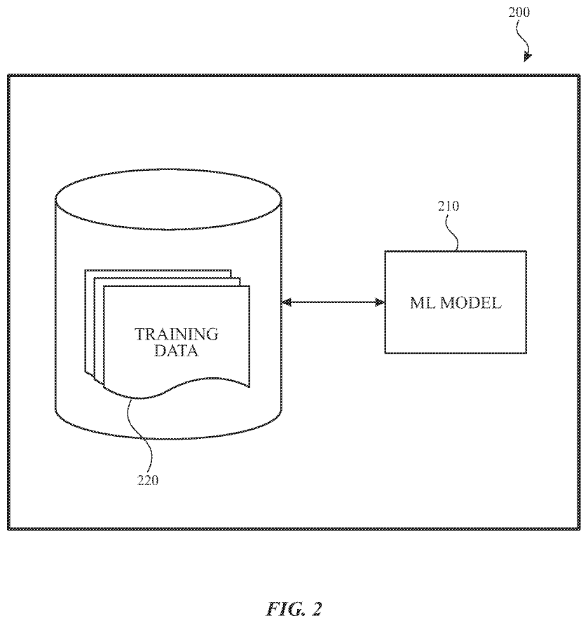

FIG. 2 illustrates an example computing architecture for a system providing for multimodal pretraining on frequency-based signals using machine learning in accordance with one or more implementations. For explanatory purposes, the computing architecture is described as being provided by an electronic device 200, such as by a processor and/or memory of the server 120, or by a processor and/or a memory of any other electronic device, such as the electronic device 110. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

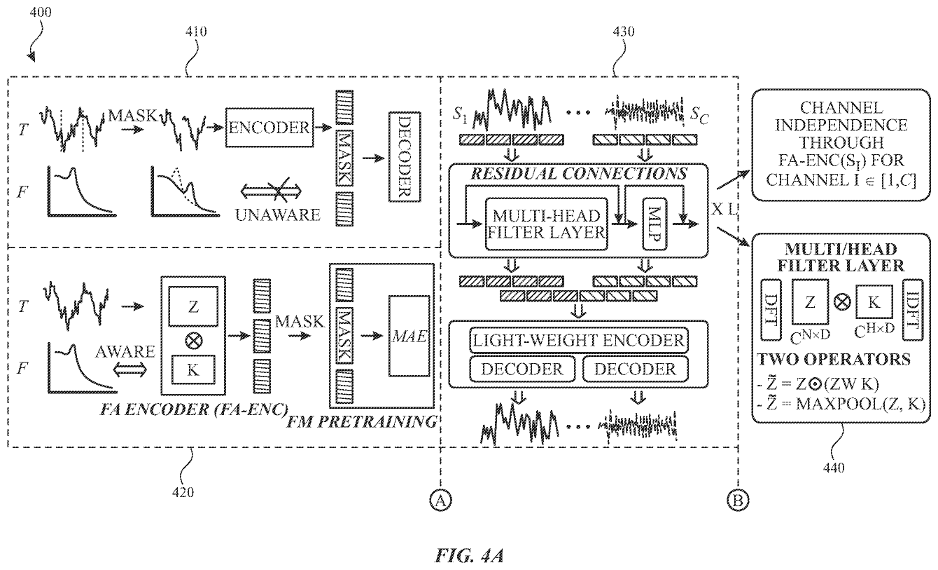

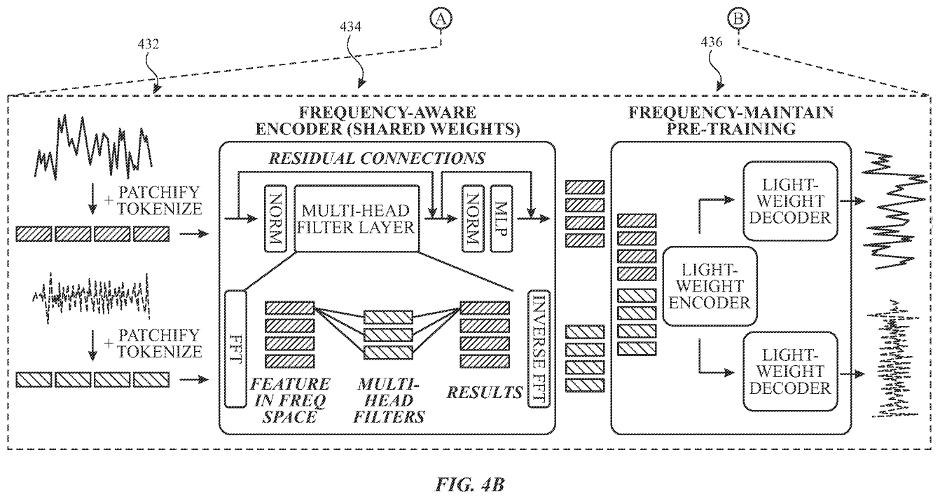

As illustrated, the electronic device 200 includes training data 210 for training a machine learning model. In an example, the server 120 may utilize one or more machine learning algorithms that uses training data 210 for training a machine learning (ML) model 220. Machine learning model 220 may include one or more neural networks, which will be described in more detail below with reference to FIG. 4.

Training data 210 may include activity information associated with measurable frequency-based signals or electrical impulses generated within a user. These signals are produced by various physiological processes in the body and carry important information about the user's health, function, and state. These frequency-based signals can be broadly categorized into different types, including: (1) Electrocardiogram (ECG/EKG), (2) Electroencephalogram (EEG); (3) Electromyogram (EMG); (4) Electrooculogram (EOG); (5) Electrodermal Activity (EDA); (6) Electroretinogram (ERG); (7) Electrogastrogram (EGG); and (8) Electrocorticography (ECoG). In some aspects, ECG/EKG may refer to a frequency-based signal that measures the electrical activity of the heart. It is commonly used to assess heart rate, rhythm, and detect abnormalities in the heart's function. In some aspects, EEG measures the electrical activity of the brain. EEG can be used for diagnosing and studying neurological conditions, monitoring brain activity during sleep, and understanding cognitive processes. In some aspects, EMG may refer to a frequency-based signal measures the electrical activity of muscles. It is useful in diagnosing neuromuscular disorders, assessing muscle function, and monitoring physical rehabilitation progress. In some aspects, EOG records the electrical activity of the muscles around the eyes and is commonly used to monitor eye movements and detect abnormalities related to vision and sleep. In some aspects, EDA may refer to a galvanic skin response (GSR) that measures the electrical conductance of the skin, which can provide information about emotional responses, stress, and arousal. In some aspects, ERG measures the electrical responses of the retina in the eye, aiding in the diagnosis of various visual disorders. In some aspects, EGG records the electrical activity of the stomach and can help in understanding gastric motility and digestive disorders. In some aspects, ECoG involves placing electrodes directly on the brain's surface, used for research and certain clinical applications like epilepsy monitoring. Training data 210 may also include demographic information (e.g., age, gender, BMI, etc.) for a user of the electronic device 110, and/or a population of other users.

### Multimodal Pretraining Methods

A goal of artificial intelligence is the creation of computer agents capable of understanding and processing information from multiple modalities. Recently, considerable research attention has been devoted to training large-scale models capable of effectively utilizing multimodal information, facilitated by the emergence of effective pre-training methods and access to large-scale datasets. Multimodal systems have been developed across various domains, encompassing vision-language systems, vision-audio systems, language-audio systems, as well as their various combinations. Furthermore, robustness has been demonstrated in learning from data with different structures and from diverse sources sharing similar underlying structures, such as different visual modalities like depth or semantic segmentations. Theoretical research has also shown that utilizing multimodal information can provably enhance the quality of latent representations.

Effective and sufficient pre-training plays a vital role in multimodal learning, given the increased diversity and dimensionality associated with multimodal inputs. Pre-training methods for learning on multiple modalities can be categorized as follows: (i) Training separate encoders for each modality, utilizing contrastive methods such as CLIP or ALIGN, which introduce novel objectives to align or fuse representations from different modalities. (ii) Designing a unified architecture for multiple modalities, with either completely shared encoders per-modality or a few shared layers for decoding, often relying on the transformer architecture. The advantage of employing a unified architecture is the ability to share weights across different modalities, reducing additional computation overhead. The subject technology provides for training a unified architecture for multimodal frequency-based signals, incorporating an effective frequency-awareness design.

### Pretraining on Frequency-Based Signals and Time Series

Frequency-based signals are multivariate time series capturing various physiological processes within the human body. Although crucial for diverse applications like sleep stage detection and disease detection, acquiring labeled frequency-based signals requires labor-intensive efforts with domain experts. To address the need for labeled data, researchers have proposed self-supervised methods to pre-train models with large-scale unlabeled datasets. These methods encompass (i) contrastive approaches, building latent representations based on similarity across samples with different augmentations, (ii) reconstruction-based techniques involving either feature reconstruction or data reconstruction, and (iii) hybrid methodologies. Pre-training on extensive data has shown to enhance downstream task performance, especially when labeled data is scarce at test time. However, existing works have primarily focused on unimodal pre-training and neglected effective utilization of multimodal information. Some even demonstrated that pre-training on multimodal data could lead to performance degradation due to significant modality variations. In contrast, the subject technology provides for multimodal pre-training on frequency-based signals, considering distributional shifts within and across modalities.

Frequency-aware approaches have been demonstrated as effective in learning multivariate time series. For instance, FED-former employs frequency space sampling to enhance time domain learning for time series processing and forecasting. Recently, the use of frequency-aware techniques has extended to frequency-based signals, where electrophysiological signals exhibit rich frequency information through periodic oscillations and analogous patterns. For instance, consistency between time and frequency spaces can be used to guide frequency-based signal learning, leading to robust performance in transfer learning scenarios by increasing network generalizability. Another approach leverages the connection between time and spectral spaces for cross reconstruction. However, prior methods face limitations: to effectively use frequency information, one must rely on a separate encoder in the frequency space or specific-purpose modules for frequency space sampling, making it computationally heavy and infeasible for irregularly sampled time series in real-world settings. Additionally, the complicated architecture hinders pre-training adaptability in a self-supervised manner without affecting frequency information. In contrast, the subject technology deviates from previous methods through its performance with a simplistic frequency-aware design and frequency-maintaining pre-training strategy.

The effectiveness of operations in the frequency space is also demonstrated in other domains, such as computer vision and long sequence processing. In computer vision, combining frequency-aware approaches into learning architectures proves effective for enhancing image fidelity and facilitating effective token mixing, particularly when integrated with transformer architectures to reduce excessive focus on local information. Additionally, mapping signals into the frequency space is found to be advantageous in long-sequence modeling, with applications in state-space models and structured global convolution networks. This can be attributed to the connection between Fourier transform and global circular convolution.

FIG. 3 conceptually illustrates an example overview 300 of frequency-aware encoding and frequency-preserving pretraining in accordance with one or more implementations. Frequency-based signals, which can be signals generated within living organisms, face challenges related to domain shifts (denoted as “A”). For example, in multimodal systems, there exists substantial distributional shifts between the pretraining and inference datasets. These domain shifts can occur within a specific modality (e.g., variations in frequency-based signal data acquired from the same type of sensor but in different conditions) and across different modalities (e.g., variations in frequency-based signal data collected from different types of sensors or sources) (denoted as “B”). In one or more implementations, these shifts can pose significant hurdles when it comes to analyzing and utilizing frequency-based signal data effectively. For example, the distributional shifts often cause the shifts of representation in time-space, which can affect the model's generalization ability within modality and across modalities. In one or more implementations, the representation in frequency-space typically would contain similar frequency components within modality, leading to more stable combinations in multimodal scenarios (denoted as “C”).

To overcome these distributional shifts and enhance the processing of frequency-based signal data, the subject technology provides for a frequency-aware multi-modal autoencoder (FAMAE). FAMAE incorporates two key strategies: a frequency-aware encoder and frequency-preserving pre-training techniques. The frequency-aware encoder may be configured to handle the frequency information present in the frequency-based signals efficiently. It allows the model to capture important frequency-related patterns and features within the data, which can facilitate addressing domain shifts and improving generalization. Furthermore, the frequency-preserving pre-training strategies are employed to combine information from various modalities. By preserving the frequency awareness during the pre-training phase, the model can build a robust and coherent representation of the frequency-based signal data that is less affected by domain shifts.

FIGS. 4A-4B are schematic diagrams illustrating an example transformer architecture 400 for performing frequency-aware encoding and frequency-preserving pretraining in accordance with one or more implementations. In one or more implementations, in FIG. 4A, approach 410 performs masking in the time domain, causing distributional shifts in the frequency components. In one or more implementations, the encoders of approach 410 are unaware of the frequency information in time series. In one or more other implementations, in FIG. 4A, approach 420 addresses the issues presented in approach 410 using frequency awareness by directly learning frequency filters in the representation space and performing masked autoencoding in the latent space to maintain frequency information during pretraining. In one or more implementations, in FIG. 4A, a multimodal pretraining scheme 430 employs a frequency-aware masked autoencoder (e.g., FA-Enc(·)) that can process signals in a channel-independent manner, and extract representations with a multi-head frequency filter layer 440 with fixed-size Fourier operators. The frequency-maintain pretraining strategy employed in the multimodal pretraining scheme 430 can further perform masked autoencoding in the latent space with separate reconstruction to guide the effective mixing of multimodal information.

The effectiveness of the transformer architecture 400 has been demonstrated in computer vision, natural language processing, and more recently, time series processing domains. The transformer architecture 400 can receive input data containing frequency-based signal information associated with one or more modalities. The individual embedding of each data patch, denoted as X₀, is obtained through an initial patchify Multi-Layer Perceptron (MLP) layer 432 as illustrated in FIG. 4B. The patchify MLP layer 432 can divide frequency-based signals into patches, compute representations for these patches, and subsequently input them into a transformer. For example, the patchify MLP layer 432 can generate multiple patches by dividing a frequency-based signal into respective ones of the multiple patches. Specifically, for a signal s∈R^{L}, where L represents the total length of the sequence, it is partitioned into sequences of S=[s₁, . . . s_{N}], where each sᵢ ∈R^{P} for 1≤i≤N. The MLP can be employed to calculate the representation xᵢ=MLP (Sᵢ)∈R^{D}, and the resulting sequence is then stacked into X∈R^{N×D}. In some examples, the subject system can generate a tokenized sequence from each of the patches.

Frequency-Aware Transformer with Multi-Head Frequency Filters

The subject technology provides for the use of the Discrete Fourier Transform (DFT) for processing frequency-based signals and vision data. Given a tokenized sequence of N numbers x∈R^{N} with elements xₙ, where 0≤n≤N−1, a one-to-one mapping exists in the frequency space z∈C^{N}. The time representation x and the frequency representation z can be interconverted using DFT F(·) and Inverse Discrete Fourier Transform (IDFT) F⁻¹(·), respectively, as illustrated below:

$$z = F ( x ) \to {z}_{k} = {\sum }_{n = 0}^{N - 1} {x}_{n} {e}^{- i ( 2 π / N ) kn} , x = {F}^{- 1} ( z ) \to {x}_{n} = \frac{1}{N} {\sum }_{k = 0}^{N - 1} {z}_{k} {e}^{i ( 2 π / N ) kn} . \qquad ( 1 )$$

The imaginary unit, denoted by i, is utilized in the context of the Fast Fourier Transform (FFT) algorithms, which capitalize on the periodicity properties and lead to a significant reduction in computational complexity from quadratic to O (N log N).

Consider a tokenized sequence X=[x₁, . . . , x_{N}]^{T}2 [symbol] of N tokens of D-dimensions, transformers aim to learn the interactions across tokens, typically through the self-attention operation. Recently, mixing tokens with frequency-based operations through DFT and IDFT is shown to be a computationally efficient alternative as it considers global-wise information mixing. The token mixing process is theoretically grounded by the Fourier Neural Operators, which is often implemented in its discrete form (denote as K) as such:

$$( K ( X ) ) ( {x}_{i} ) = {F}^{- 1} ( R \cdot F ( X ) ) ( {x}_{i} ) , {∀}_{i} ∈ [ 1 , N ] . \qquad ( 2 )$$

Ideally, it is desired for R to be the Fourier transform of a periodic function that allows a Fourier series expansion. To simplify matters, the implementation often takes the form of learnable weights with a shape of [symbol] .

### Multi-Head Frequency Filter Layer

The transformer architecture includes a frequency-aware transformer encoder 434 as illustrated in FIG. 4B. In order to effectively incorporate frequency awareness into the transformer architecture 400, a novel approach is proposed, which involves replacing the multi-head self-attention layer with the multi-head frequency filter layer 440 in the frequency-aware transformer encoder 434.

In this regard, instead of employing the multi-head self-attention operation, the subject technology utilizes the multi-head frequency filter layer 440 to facilitate information mixing across a sequence of tokens. The signal is passed through the transformer layer in the following manner:

$${X}_{ℓ + 1} = {X}_{ℓ} + Freq - L ( {X}_{ℓ} ) + FF ( {X}_{ℓ} + Freq - L ( {X}_{ℓ} ) ) , ℓ = \{ 0 , … , L - 1 \} . \qquad ( 3 )$$

Each transformer layer is a combination of the multi-head frequency filter layer 440 (Freq-L(·)), the projection (FF(·)), and residual connections.

For a sequence of tokens X∈R^{N×D}, where N represents the total number of tokens, and D denotes the dimensionality of each token, a DFT is initially performed along the patch dimension to generate representations in the frequency space, resulting in Z∈C^{N×D}. To ensure learnability and transferability across frequency-based signals with varying input lengths, the frequency representation is manipulated using multi-head frequency filters K∈C^{H×D}, where H signifies the total number of heads.

Two variants of the model are developed to achieve the manipulated features in frequency space, denoted as \tilde{Z}∈C^{N×D}. In the first variant, the system computes queries Q=ZᵣₑₐₗW based on the real values of Z, where W E R^{D×H} is a learnable matrix in real space, facilitating simpler manipulation. These resulting queries are utilized to re-weight the kernels, thus obtaining \tilde{Z} through the following operation:

$$\tilde{Z} = Z ⊙ ( QK ) = Z ⊙ ( ZWK ) , \qquad ( 4 ) .$$

In one or more implementations, additional intuition for the multi-head frequency filter layer 440 can be provided by breaking down the computation for each individual filter. For each k-th filter K[k] inside K∈ [symbol] , given latent representation Z=[z₁, z₂ . . . Z_{N}]^{T}∈ [symbol] , the expression Z^{(k)}=[z₁⊙K[k], z₂⊙K[k], . . . , Z_{N}⊙K[k]]^{T} can be computed, where ⊙ represents the Hadamard product between each representation and the learnable filter weights. To learn the combination between different filters, the weights w can be defined that compute \tilde{Z}=Σₖ₌₁^{H}wₖZ^{(k)}. In one or more other implementations, to increase the expressiveness of the filtering operation, instead of learning a linear combination of different filters, intuition can be borrowed from the computation of self-attention to compute the queries for the kernel weights w through w=zW, where W∈ [symbol] . Thus, \tilde{Z}[i, j] can be defined as follows:

$$\tilde{Z} [ i , j ] = {\sum }_{k = 1}^{H} ( {\sum }_{j = 1}^{D} Z [ i , j ] W [ j , k ] Z [ i , j ] K [ k , j ] ) . \qquad ( 5 )$$

$$= Z [ i , j ] {\sum }_{k = 1}^{H} ( {\sum }_{j = 1}^{D} Z [ i , j ] W [ j , k ] K [ k , j ] )$$

This expression can yield expression (4) described above. Embodiments of the subject technology utilize the real values of latents to learn the weights of the combiner through w=ZᵣₑₐₗW. Similarly, based on the same intuition of combining filtered matrices, the max pooling operation can be realized.

In one or more implementations, the aforementioned operation is equivalent to a self-guided weighted summation between each query and its corresponding modulated frequency representation. Some approaches may utilize filters K of the same shape as Z for element-wise multiplication, which is may not be suitable for time series due to potential significant changes in input length. In contrast, the subject technology employs a flexible multi-head kernel K with a size of N, ensuring model transferability across different subjects and tasks.

Alternatively, the modulated spectral feature matrix \tilde{Z} can be obtained by applying each row of K to every row of Z, followed by a max-pooling operation:

$$\tilde{Z} [ i , j ] = {max}_{k} Z [ i , j ] K [ k , j ] . \qquad ( 6 )$$

The max-pooling operation is performed based on the absolute value of the complex features to obtain the resulting feature in frequency space, denoted as \tilde{Z}. Subsequently, the feature is converted back to a representation in time space using the Inverse Discrete Fourier Transform (IDFT), resulting in \tilde{X}=F⁻¹(Z). The entire process is denoted as Freq-L(·), ensuring computational efficiency, transferability, and robustness.

### Masked Autoencoding in the Latent Space

The self-supervised pre-training framework, masked autoencoder (MAE) implemented as a frequency-maintain pre-training circuit 436 as illustrated in FIG. 4B, involves masking out input patches and predicting the missing patches using the remaining present patches. For example, the masked autoencoder can generate a masked frequency-embedded latent representation by masking one or more frequency components in the frequency-embedded latent representation. The transformer architecture includes the frequency-aware transformer encoder 434 that processes non-masked patches, followed by a decoder, often a lightweight transformer, responsible for reconstructing the original patches.

To preserve frequency information while enabling pre-training based on the masked autoencoding strategy, masked autoencoding is performed in the latent space using the frequency-maintain pre-training circuit 436. The frequency-aware transformer encoder 434, denoted as FA-Enc(·), learns the full sequence of frequency-based signals S to obtain X_{L}=[x₁^{L}, x₂^{L}, . . . , x_{N}^{L}]. Patches are randomly sampled with a fixed masking ratio to obtain Zₘₐₛₖ, and then processed by a lightweight transformer encoder. The resulting latents are padded with mask tokens and fed to a lightweight transformer decoder to reconstruct \tilde{s}ᵢ, corresponding to the original signal sᵢ. In this regard, the subject technology can produce a trained machine learning model by training a neural network to predict one or more masked frequency components of the frequency-embedded latent representation.

Referred to as MAE(·), FAMAE is designed to optimize the objective below:

$$L = \frac{1}{Ω} {\sum }_{iϵΩ} l ( {s}_{i} , MAE ( FA - Enc ( S ) ) [ i ] ) . \qquad ( 7 )$$

In the expression above, Ω is the set of masked tokens. The computation of offsets between original signal patches and reconstructed patches is accomplished using the error term l, set as mean squared error (MSE) in experiments. In some aspects, the performance remains robust when MAE(·) is removed, and only keep FA-Enc(·) is retained during test time. The novelty lies in the observation that utilizing the masked autoencoding objective alone, without any contrastive terms, proves to be effective for frequency-based signals.

### Channel and Modality Independence

Frequency-based signals are multivariate time series that often face channel-wise and modality-wise mismatch scenarios at test time. To obtain robust transfer performance, a channel-independent design may be implemented to model multimodal frequency-based signals.

A multi-channel frequency-based signal [S₁, S₂, . . . , S_{C}] is provided, where C represents the total number of channels. In one or more implementations, channel independence can be performed through FA-Enc (Sᵢ) for channel i∈[1, C]. The channel independence design is implemented by passing each S_{ξ} into FA-Enc(·), and MAE(·) is utilized as illustrated below:

$$L = \frac{1}{Ω} {\sum }_{i ∈ Ω} l ( {s}_{i} , MAE ( [ FA - Enc ( {S}_{1} ) , … , FA - Enc ( {S}_{C} ) ] ) [ i ] ) . \qquad ( 8 )$$

In the expression, Ω is the union of masked tokens for each channel, which is independently determined based on a fixed masking ratio for each channel. The transformer architecture 400 incorporates MAE, featuring one lightweight transformer encoder for information mixing across channels and separate lightweight decoders for reconstruction. The weight of the frequency-aware transformer FA-Enc(·) is shared across channels. By integrating this channel independence into the multi-modal masked autoencoding objective, the subject technology gains the advantage of robustness against multimodal domain shifts, encompassing (i) shifts in connections across channels or modalities and (ii) scenarios with empty or additional channels or modalities, referred to as “channel dropout” and “channel substitute,” respectively.

In one or more implementations, in transfer tasks, embodiments of the subject technology utilize the average of tokens to extract the final representations for the downstream classification. In one or more other implementations, when having multimodal information, fixing the dimensionality of the latent representation when many modalities are present can narrow down the information from each modality, causing potential information loss. Thus, in multimodal tasks, embodiments of the subject technology average the representations from each individual modality, and then concatenate the representations across modalities before performing the downstream classification.

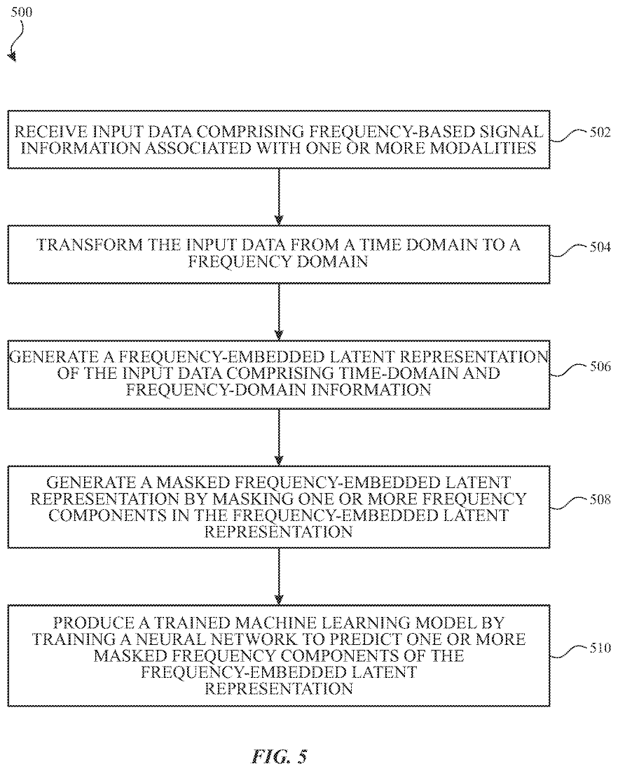

FIG. 5 is a flow chart of an example process that may be performed for frequency-aware encoding and frequency-preserving pretraining in accordance with one or more implementations. For explanatory purposes, the process 500 is primarily described herein with reference to the electronic device 110 of FIG. 1. However, the process 500 is not limited to the electronic device 110 of FIG. 1, and one or more blocks (or operations) of the process 500 may be performed by one or more other components of other suitable devices and/or servers. Further for explanatory purposes, some of the blocks of the process 500 are described herein as occurring in serial, or linearly. However, multiple blocks of the process 500 may occur in parallel. In addition, the blocks of the process 500 need not be performed in the order shown and/or one or more blocks of the process 500 need not be performed and/or can be replaced by other operations.

As illustrated in FIG. 5, at block 502, an apparatus (e.g., the electronic device 110, 112, 114, 116, 118) receives input data comprising frequency-based signal information associated with one or more modalities.

At block 504, the apparatus transforms the input data from a time domain to a frequency domain.

At block 506, the apparatus generates a frequency-embedded latent representation of the input data comprising time-domain and frequency-domain information.

At block 508, the apparatus generates a masked frequency-embedded latent representation by masking one or more frequency components in the frequency-embedded latent representation.

At block 510, the apparatus produces a trained machine learning model by training a neural network to predict one or more masked frequency components of the frequency-embedded latent representation.

FIG. 6 illustrates an electronic system 600 with which one or more implementations of the subject technology may be implemented. The electronic system 600 can be, and/or can be a part of, the electronic device 110, and/or the server 120 shown in FIG. 1. The electronic system 600 may include various types of computer readable media and interfaces for various other types of computer readable media. The electronic system 600 includes a bus 608, one or more processing unit(s) 612, a system memory 604 (and/or buffer), a ROM 610, a permanent storage device 602, an input device interface 614, an output device interface 606, and one or more network interfaces 616, or subsets and variations thereof.

The bus 608 collectively represents all system, peripheral, and chipset buses that communicatively connect the numerous internal devices of the electronic system 600. In one or more implementations, the bus 608 communicatively connects the one or more processing unit(s) 612 with the ROM 610, the system memory 604, and the permanent storage device 602. From these various memory units, the one or more processing unit(s) 612 retrieves instructions to execute and data to process in order to execute the processes of the subject disclosure. The one or more processing unit(s) 612 can be a single processor or a multi-core processor in different implementations.

The ROM 610 stores static data and instructions that are needed by the one or more processing unit(s) 612 and other modules of the electronic system 600. The permanent storage device 602, on the other hand, may be a read-and-write memory device. The permanent storage device 602 may be a non-volatile memory unit that stores instructions and data even when the electronic system 600 is off. In one or more implementations, a mass-storage device (such as a magnetic or optical disk and its corresponding disk drive) may be used as the permanent storage device 602.

In one or more implementations, a removable storage device (such as a flash drive, and its corresponding solid state drive) may be used as the permanent storage device 602. Like the permanent storage device 602, the system memory 604 may be a read-and-write memory device. However, unlike the permanent storage device 602, the system memory 604 may be a volatile read-and-write memory, such as random access memory. The system memory 604 may store any of the instructions and data that one or more processing unit(s) 612 may need at runtime. In one or more implementations, the processes of the subject disclosure are stored in the system memory 604, the permanent storage device 602, and/or the ROM 610. From these various memory units, the one or more processing unit(s) 612 retrieves instructions to execute and data to process in order to execute the processes of one or more implementations.

The bus 608 also connects to the input device interface 614 and output device interface 606. The input device interface 614 enables a user to communicate information and select commands to the electronic system 600. Input devices that may be used with the input device interface 614 may include, for example, alphanumeric keyboards and pointing devices (also called “cursor control devices”). The output device interface 606 may enable, for example, the display of images generated by electronic system 600. Output devices that may be used with the output device interface 606 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 6, the bus 608 also couples the electronic system 600 to one or more networks and/or to one or more network nodes, such as the electronic device 110 shown in FIG. 1, through the one or more network interface(s) 616. In this manner, the electronic system 600 can be a part of a network of computers (such as a LAN, a wide area network (“WAN”), or an Intranet, or a network of networks, such as the Internet. Any or all components of the electronic system 600 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method, comprising:
receiving input data comprising frequency-based signal information;
transforming the input data from a time domain to a frequency domain;
generating a frequency-embedded latent representation of the input data comprising time-domain information and frequency-domain information;
generating a masked frequency-embedded latent representation by masking one or more frequency components in the frequency-embedded latent representation; and
producing a trained machine learning model by training a neural network to predict one or more masked frequency components of the frequency-embedded latent representation.

2. The method of claim 1, further comprising applying the trained machine learning model to extract one or more features from user physiological information associated with one or more modalities.

3. The method of claim 1, further comprising deploying the trained machine learning model to an electronic device to extract one or more features from user physiological information associated with one or more modalities.

4. The method of claim 1, wherein receiving the input data comprises:
generating a plurality of patches by dividing the input data into respective ones of the plurality of patches; and
generating a tokenized sequence of each patch of the plurality of patches.

5. The method of claim 4, wherein generating the frequency-embedded latent representation comprises:
generating a frequency domain representation of the tokenized sequence;
obtaining one or more features in frequency space from the frequency domain representation of the tokenized sequence; and
generating a time domain representation of the one or more features.

6. The method of claim 5, further comprising:
obtaining a learned sequence of frequency-based signals by applying a learning operation to the one or more features via a multi-head filter layer with a linear combination of different filter weights of the multi-head filter layer.

7. The method of claim 1, wherein generating the masked frequency-embedded latent representation comprises:
performing masked autoencoding in a latent space to maintain frequency information during pretraining.

8. The method of claim 1, wherein generating the masked frequency-embedded latent representation comprises:
performing masked autoencoding of the frequency-embedded latent representation in a latent space using a frequency-maintain pretraining circuit, wherein the frequency-maintain pretraining circuit comprises an encoder and a plurality of decoders.

9. The method of claim 8, wherein performing the masked autoencoding comprises:
masking at least a portion of the frequency-embedded latent representation based on a masking ratio; and
processing a non-masked portion of the frequency-embedded latent representation into an encoded portion using the encoder.

10. The method of claim 9, wherein performing the masked autoencoding comprises:
reconstructing the frequency-based signal in a first modality by decoding the encoded portion using one of the plurality of decoders associated with the first modality on a first channel; and
reconstructing the frequency-based signal in a second modality different from the first modality by decoding the encoded portion using one of the plurality of decoders associated with the second modality on a second channel independent of the first channel.

11. A device, comprising:
a memory; and
one or more processors configured to:
receive input data comprising frequency-based signal information;
transform the input data from a time domain to a frequency domain;
generate a frequency-embedded latent representation of the input data comprising time-domain information and frequency-domain information;
generate a masked frequency-embedded latent representation by masking one or more frequency components in the frequency-embedded latent representation; and
produce a trained machine learning model by training a neural network to predict one or more masked frequency components of the frequency-embedded latent representation.

12. The device of claim 11, wherein the one or more processors are further configured to receive the input data by:
generating a plurality of patches by dividing the input data into respective ones of the plurality of patches; and
generating a tokenized sequence of each patch of the plurality of patches.

13. The device of claim 12, wherein the one or more processors are further configured to generate the frequency-embedded latent representation by:
generating a frequency domain representation of the tokenized sequence;
obtaining one or more features in frequency space from the frequency domain representation of the tokenized sequence; and
generating a time domain representation of the one or more features.

14. The device of claim 13, wherein the one or more processors are further configured to:
obtain a learned sequence of frequency-based signals by applying a learning operation to the one or more features via a multi-head filter layer with a linear combination of different filter weights of the multi-head filter layer.

15. The device of claim 11, wherein the one or more processors are further configured to generate the masked frequency-embedded latent representation by:
performing masked autoencoding in a latent space to maintain frequency information during pretraining.

16. The device of claim 11, wherein the one or more processors are further configured to generate the masked frequency-embedded latent representation by:
performing masked autoencoding of the frequency-based signal in a latent space using a frequency-maintain pretraining circuit, wherein the frequency-maintain pretraining circuit comprises an encoder and a plurality of decoders.

17. The device of claim 16, wherein the one or more processors are further configured to perform the masked autoencoding by:
masking at least a portion of the frequency-embedded latent representation based on a masking ratio; and
processing a non-masked portion of the frequency-based signal into an encoded portion using the encoder.

18. The device of claim 17, wherein the one or more processors are further configured to perform the masked autoencoding by:
reconstructing the frequency-based signal in a first modality by decoding the encoded portion using one of the plurality of decoders associated with the first modality on a first channel; and
reconstructing the frequency-based signal in a second modality different from the first modality by decoding the encoded portion using one of the plurality of decoders associated with the second modality on a second channel independent of the first channel.

19. The device of claim 11, wherein the one or more processors are further configured to apply the trained machine learning model to extract one or more features from user physiological information between one or more modalities.

20. A non-transitory machine-readable medium comprising code that, when executed by a processor, causes the processor to perform operations comprising:
receiving input data comprising frequency-based signal information;
transforming the input data from a time domain to a frequency domain;
generating a frequency-embedded latent representation of the input data comprising time-domain information and frequency-domain information;
generating a masked frequency-embedded latent representation by masking one or more frequency components in the frequency-embedded latent representation; and
producing a trained machine learning model by training a neural network to predict one or more masked frequency components of the frequency-embedded latent representation.
